(19) United States
(12) Patent Application Publication
(10) Pub. No.: US 2006/0229750 A1
(43) Pub. Date: Oct. 12, 2006

(54) System and method for providing access to supplemental program services

(76) Inventor: Charles Rozier, Westport, CT (US)

Correspondence Address: SHEEHAN PHINNEY BASS & GREEN, PA;c/o PETER NIEVES, 1000 ELM STREET, MANCHESTER, NH, 03105-3701, US

(21) Appl. No.: 11/103,741

(22) Filed: Apr. 12, 2005

(51) Int. Cl. G06F 17/00

(52) U.S. Cl. 700/94

(57) ABSTRACT

A system and method for providing access to supplemental program services is provided. Generally, the system contains an antenna, a display, a control device, a memory, and a processor configured by the memory. The processor is configured by the memory to perform the steps of: sequentially arranging the audio programs received by the system in accordance with a representation of a carrier frequency, where the audio programs comprise at least one main program service and at least one supplemental program service, the main program service being located within the sequential arrangement at a location of a first carrier frequency at which the main program service was received, and the at least one supplemental program service received at the first carrier frequency being sequentially listed near the main program service; and displaying the sequentially arranged programs on the display so that the programs may be searched by use of the control device.

### FIELD OF THE INVENTION

The present invention is generally related to audio devices, and more particularly is related to a system and method for providing access to supplemental program services.

### BACKGROUND OF THE INVENTION

Traditional audio broadcasting is performed via analog broadcasting formats. As is well known by the public, such analog broadcasting formats are limited in performance due to signal degradation. Such signal degradation may be caused by factors such as, but not limited to, fading and shadowing. As is known by those having ordinary skill in the art, fading is characterized as the multiple reflections of a signal from the terrain, such as from hills and mountains, or from buildings. In addition, shadowing is characterized as the blocking of a signal by terrain or buildings.

Digital audio broadcasting (DAB) was introduced to address the inadequacies of analog broadcasting formats. In digital audio broadcasting, also referred to as digital radio or high-definition radio, an analog signal is converted into a digital signal and transmitted on an assigned channel, also referred to as a carrier frequency, in the amplitude modulation (AM) range, frequency modulation (FM) frequency range, or in a different frequency range. Digital audio broadcast signals may be transmitted, for example, in-band, on-channel (IBOC).

IBOC DAB can be transmitted in a hybrid format, where a digital audio broadcast is transmitted in addition to an analog audio broadcast, or in an all-digital format, where only a digital audio broadcast is provided. By providing both the hybrid format and the all-digital format, receivers that are not capable of receiving a digital audio broadcast will still be capable of playing the analog audio broadcast provided by the hybrid format.

Typical DAB receivers contain a display that provides information regarding audio content being played in much the same way that a menu screen provides an overview of programs in digital television. Specifically, the call station identification letters, and carrier frequency of a tuned radio station may be displayed on the display of a DAB receiver, in addition to the title of a presently playing song. Tuning of such DAB receivers is typically provided by pressing a tuning button in a specific direction to tune to a specific carrier frequency, resulting in receiving an associated audio broadcast.

Advancements in DAB technologies have resulted in the possibility of transmitting more than one program service at a time to the DAB receiver on a single channel. Specifically, it is now possible to transmit a main program service and a supplemental program service. In such advanced IBOC technologies, a typically transmitted main program service may be accompanied by the transmission of multiple supplemental program services, all within the same audio transmission. It is therefore desirable to provide a user of a DAB receiver (i.e., high definition radio) with a simplistic method for searching and selecting between the main program service and the supplementary program services, while also being able to search and select between standard analog audio broadcasts.

Thus, a heretofore unaddressed need exists in the industry to address the aforementioned deficiencies and inadequacies.

### SUMMARY OF THE INVENTION

Embodiments of the present invention provide a system and method for providing access to supplemental program services. Briefly described, in architecture, one embodiment of the system, among others, can be implemented as follows. The system contains an antenna, a display, a control device, a memory, and a processor. The processor is configured by the memory to perform the steps of: sequentially arranging the audio programs received by the system in accordance with a representation of a carrier frequency, where the audio programs comprise at least one main program service and at least one supplemental program service, the main program service being located within the sequential arrangement at a location of a first carrier frequency at which the main program service was received, and the at least one supplemental program service received at the first carrier frequency being sequentially listed near the main program service; and displaying the sequentially arranged programs on the display so that the programs may be searched by use of the control device.

The present invention can also be viewed as providing methods for providing access to supplemental program services. In this regard, one embodiment of such a method, among others, can be broadly summarized by the following steps: sequentially displaying representations of carrier frequencies of received audio broadcasts; receiving a selection of an analog audio stream, wherein the analog audio stream is one of the received audio broadcasts; determining if a digital audio stream, which provides a digital version of the selected analog audio stream, is available, the digital version of the analog audio stream being referred to herein as a main program service; determining if the digital audio stream comprises the at least one supplemental program service; and sequentially displaying the main program service and the at least one supplemental program service, if the digital audio stream comprises the at least one supplemental program service.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating a digital audio broadcasting (DAB) receiver, in accordance with a first exemplary embodiment of the invention.

FIG. 2 is a schematic diagram further illustrating the computer of FIG. 1, in accordance with the first exemplary embodiment of the invention.

FIG. 3 is a flowchart illustrating a method of providing a user of the DAB receiver of FIG. 1 with access to a received analog audio signal broadcast and a received digital audio signal broadcast, in accordance with the first exemplary embodiment of the invention.

FIG. 4 is a flowchart further illustrating the steps of formatting and presenting received analog audio streams and digital audio streams, as performed by the computer located within the DAB receiver of FIG. 1.

FIG. 5 is an example of a screen display illustrating sequential arrangement of call letters.

FIG. 6 is a flowchart further illustrating the steps of formatting and presenting received analog audio streams and digital audio streams, as performed by the computer located within the DAB receiver of FIG. 1, if the DAB receiver also receives digital audio broadcasts at a carrier frequency that is different from the carrier frequency used to transmit analog audio broadcasts.

### DETAILED DESCRIPTION

The following describes a digital audio broadcasting (DAB) receiver that is capable of providing a user with simplistic sequential access to program services received by an analog audio broadcast and program services received by a digital audio broadcast, where the program services received by a digital audio broadcast may be either main program services and/or supplemental program services. It should be noted that, while the present description is focused on the DAB receiver being a radio, one having ordinary skill in the art would appreciate that the DAB receiver may instead be part of any other device capable of receiving a digital broadcast. In addition, while the present description is focused on the DAB receiver being capable of providing a user with access to program services received by an analog audio broadcast and by a digital audio broadcast, the DAB receiver may instead be capable of providing user access to program services received by a digital audio broadcast only.

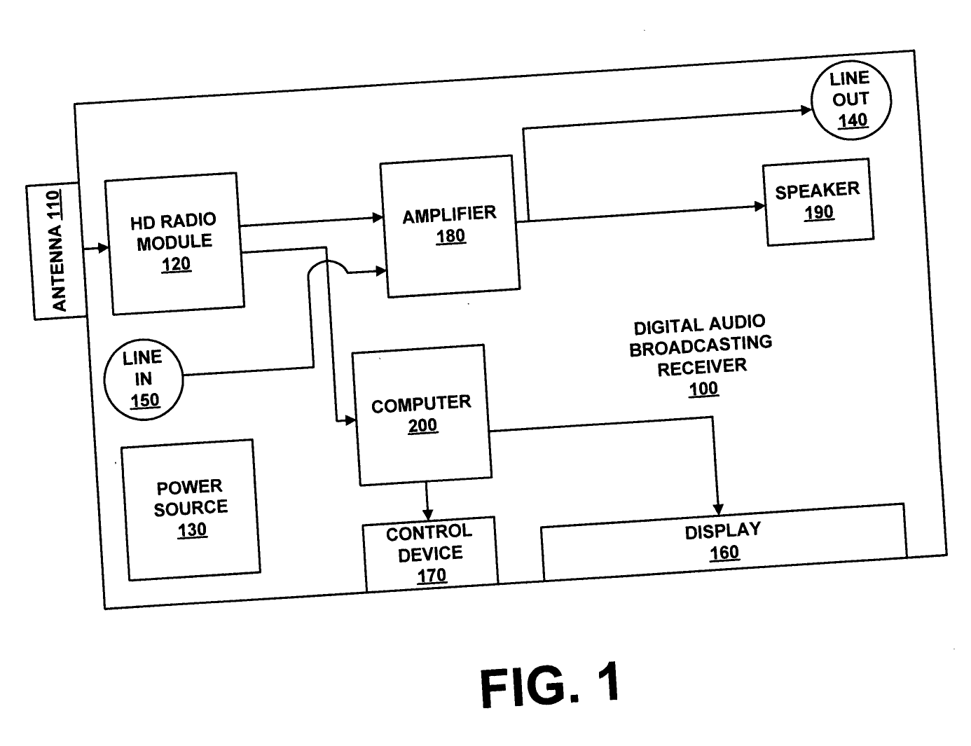

FIG. 1 is a block diagram of the DAB receiver 100, in accordance with a first exemplary embodiment of the invention. As is shown by FIG. 1, the DAB receiver 100 contains an antenna 110. The antenna 110 may be any antenna that is capable of receiving both analog audio broadcasts and digital audio broadcasts (i.e., broadcasted analog and digital audio signals). It should be noted that the digital audio broadcasts may include compressed digital signals having an audio component and a data component. It should also be noted that a different device for allowing receiving of both analog and digital audio signals might be utilized. As an example, a cable system may be utilized.

The antenna 110 is connected to a high definition (HD) radio module 120. The HD radio module 120 is capable of receiving, from the antenna 110, broadcasted digital audio signals and broadcasted analog audio signals received by the antenna 110. It should be noted that the received broadcasted digital audio signals may be broadcasted alongside the broadcasted analog audio signals, specifically, using the same carrier frequency. Technology for transmission and receipt of digital audio signals broadcasted alongside broadcasted analog audio signals (i.e., using the same carrier frequency) is provided by companies such as, iBiquity Digital Corporation, of Columbia, Md. An example of a system and method used by iBiquity Digital Corporation for allowing digital audio signals to be broadcasted alongside broadcasted analog audio signals is described in detail in U.S. Pat. No. 6,510,175, entitled “IN-BAND ON-CHANNEL DIGITAL BROADCASTING”, filed Oct. 8, 1998, which is assigned to iBiquity Digital Corporation, and which is incorporated herein by reference.

Broadcasted digital audio signals received by the HD radio module 120 may be part of a main program service or a supplemental program service. Specifically, as is explained in more detail below, received digital audio signals are parsed by the HD radio module 120 to determine what portions of an associated digital audio stream are part of a main program service and what portions of the digital audio stream are part of a supplemental program service. It should be noted that the process of formatting digital audio signals to include both a main program service and a supplemental program service is taught by iBiquity Digital Corporation. Since the process of formatting digital audio signals to include both main program service and supplemental program service is not considered to be a part of the present invention, minor descriptions of this process are provided herein. Instead, the present description focuses on the handling and presenting of received digital audio broadcasts and analog audio broadcasts, including main program services and supplemental program services, as performed by the DAB receiver 100.

The HD radio module 120 processes received analog audio signals and digital audio signals, as is described hereafter. Analog audio signals received by the HD radio module 120 are demodulated by the HD radio module 120 to remove a carrier signal, having a carrier frequency, from the received analog audio signals, resulting in an analog audio stream. Received digital audio signals are also demodulated to remove a carrier signal from the received digital audio signals, resulting in a digital audio stream. It should be noted that received analog audio signals and received digital audio signals may be carried by the same carrier signal.

In addition to removing carrier signals, the HD radio module 120 is capable of decompressing digital audio signals within the digital audio stream. After decompressing the digital audio signals, the HD radio module 120 parses data packets, located within digital audio signals, to determine what portions of the digital audio stream are part of a main program service and what portions of the digital audio stream are part of a supplemental program service.

It should be noted that data regarding the digital audio stream is also made available during parsing of the data packets. As an example, such data may include, but is not limited to, station identification call letters, the carrier frequency at which the digital audio stream was received, the name of a song associated with the digital audio stream, and an artist associated with the digital audio stream.

An example of a device that performs functions defined by the HD radio module 120 is a single-chip baseband manufactured by Texas Instruments Inc. of Dallas, Tex., having part number TMS320DRI350. This single-chip baseband is capable of performing baseband processing for high definition radio and intermediate frequency sampled AM/FM on a single device. It should be noted, however, that other devices may be used in the alternative, and this device is described merely as an example.

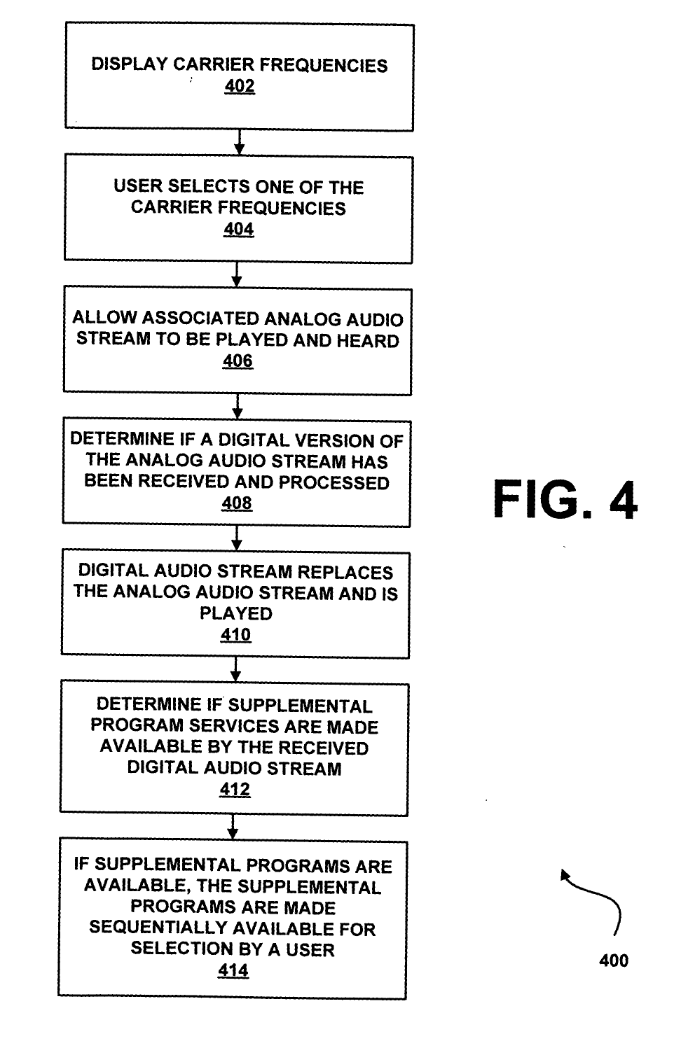

The analog audio stream, the portions of the digital audio stream that are part of the main program service, and the portions of the digital audio stream that are part of the supplemental program service, are received by a computer 200 located within the DAB receiver 100. The computer 200 is connected to both the HD radio module 120 and a display 160. The computer 200 formats received analog audio streams and digital audio streams for presenting to a user of the DAB receiver 100. Formatting and presenting of the received analog audio streams and digital audio streams, as performed by the computer 200, is described in detail below with reference to FIG. 4.

The display 160 is located within the DAB receiver 100 for presenting information regarding received analog audio streams and digital audio streams, after the audio streams have been formatted by the computer 200. Specifically, as is explained in further detail below with reference to FIG. 4, by using the display 160, the DAB receiver 100 is capable of visually making the received analog audio streams and digital audio streams available to the user of the DAB receiver 100 for selection. It should be noted that the digital audio streams made available to the user of the DAB receiver 100 include main program services and/or supplemental program services.

The DAB receiver 100 makes the analog audio streams and digital audio streams available to the user for selection by displaying the carrier frequency of the analog audio streams and associated station identification call letters, and data received during parsing of the data packets. Such data received during parsing of the data packets includes, but is not limited to, the carrier frequency on which a digital audio broadcast was received, station identification call letters of a main program service transmitted on the carrier frequency, and station identification call letters for each supplemental program service also transmitted on the carrier frequency. In addition, if a main program service or a supplemental program service is selected, the display 160 may illustrate the name of a song associated with the digital audio stream and an artist associated with the digital audio stream. Displaying the carrier frequency of the analog audio streams and data received during parsing of data packets is described in further detail with regard to FIG. 4. Of course, all of the above does not have to be displayed. Instead, different combinations of the above may be displayed.

In accordance with an alternative embodiment of the invention, the display 160 may not be located within the DAB receiver 100. Alternatively, the display 160 may be located at a location remote from the DAB receiver 100, where the display 160 is either in wired communication with the DAB receiver 100 or in wireless communication with the DAB receiver 100.

The display 160 may be selected from many different types of displays, such as, but not limited to, a light emitting diode (LED) display, a digital display, or any other display. One having ordinary skill in the art would appreciate that other displays may be substituted.

The DAB receiver 100 also contains a control device 170 for allowing a user of the DAB receiver 100 to initially select an analog audio broadcast or a digital audio broadcast received by the DAB receiver 100, processed by the HD radio module 120, formatted by the computer 200, and presented by the display 160. In addition, as is further explained with reference to FIG. 4, the control device 170 may also be used to select from a main program service or supplemental program services formatted by the computer 200 and illustrated by the display 160.

The control device 170 may be one of many different devices that are capable of being used by a user of the DAB receiver 100 to select a carrier frequency or station identification call letters illustrated on the display 160, and then, if made available, select from a main program service or supplemental program services. As an example, the control device 170 may be a tuning knob that is capable of allowing a user to scan through available carrier frequencies, station identification call letters, main program services and/or supplemental program services, by turning the tuning knob clockwise or counterclockwise. In addition, the control device 170 may contain an “up button” and a “down button,” or a single button having a clockwise scanning feature and a counterclockwise scanning feature. Of course, other types of control devices 170 may be provided.

An amplifier 180 is also located within the DAB receiver 100 for amplifying an analog audio stream and/or a digital audio stream after selection by use of the control device 170. Specifically, the analog audio stream and/or digital audio stream is amplified for transmission to a speaker 190 located within the DAB receiver 100, where the speaker 190 is capable of converting the amplified analog audio stream and/or digital audio stream into sound. It should be noted that more than one speaker 190 might be located within the DAB receiver 100. In addition, as an example, the amplifier 180 may be a pulse width modulated (PWM) amplifier, or a class AB audio amplifier.

As is shown by FIG. 1, the DAB receiver 100 also contains a power source 130 for providing power to the DAB receiver 100. It should be noted that while FIG. 1 illustrates the power source 130 as being located within the DAB receiver 100, the power source 130 may alternatively be replaced by a connection to an externally located power source. In such an alternative embodiment of the invention, the power source 130 would be replaced by an AC/DC converter or a different converter.

It should be noted that the DAB receiver 100 may also communicate with different output or external devices that have not been mentioned thus far. To communicate with such output devices, the DAB receiver 100 may contain a line out output port 140, as is shown in FIG. 1. The line out output port 140 allows an external device to be connected to the DAB receiver 100 to allow a user of the external device to hear sounds provided by the DAB receiver 100. As an example, a set of headphones may be connected to the DAB receiver 100 via the line out output port 140. Alternatively, the line out output port 140 may be separated into more than one line out output port 140. As an example, the line out output port 140 may contain a line out left port and a line out right port. Since such ports are known to those having ordinary skill in the art, further description of such ports is not provided herein.

The DAB receiver 100 may also receive communications from different input devices, in addition to the antenna 110. To receive communications from such input devices, the DAB receiver 100 may also contain a line in input port 150, as is shown in FIG. 1. An example of a line in input port 150 may be, for example, an auxiliary audio input port. It should be noted that if the line in input port 150 is an auxiliary input port, the DAB receiver 100 may also contain an analog to digital converter (not shown).

Different pre-select buttons (not shown) may also be provided on the DAB receiver 100. While the pre-select buttons may allow a user of the DAB receiver 100 to assign specific carrier frequencies to specific pre-select buttons, in accordance with an alternative embodiment of the invention, the pre-select buttons may also be assigned to specific supplemental service programs. This process is described in further detail with regard to the description of FIG. 4, provided herein. It should be noted that if a pre-select button is assigned to a specific supplemental service program and the pre-select button is selected, the DAB receiver 100 might be placed in a mute condition while the DAB receiver 100 waits for an associated digital audio signal.

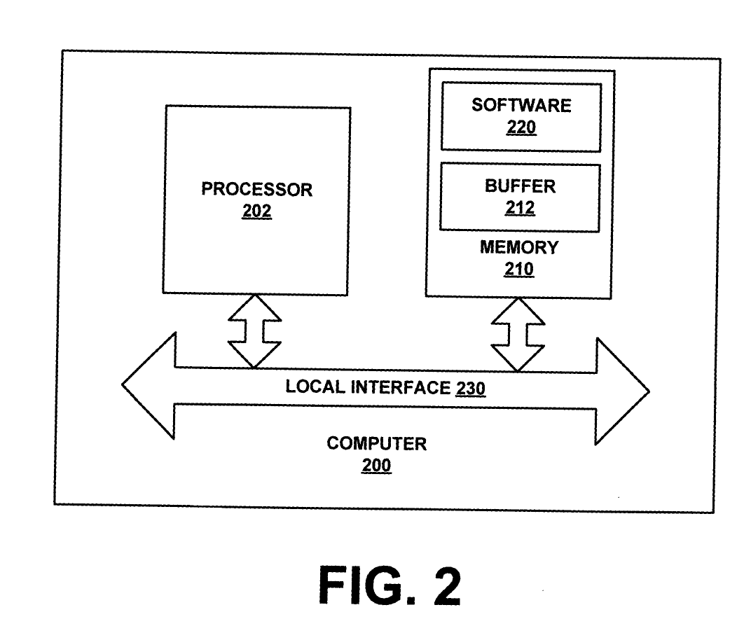

FIG. 2 is a schematic diagram further illustrating the computer 200 of FIG. 1, in accordance with the first exemplary embodiment of the invention. Referring to FIG. 2, generally, in terms of hardware architecture, the computer 200 includes a processor 202, a memory 210, and software 220 located within the memory 210, that are communicatively coupled via a local interface 230. The local interface 230 can be, for example but not limited to, one or more buses or other wired or wireless connections, as is known in the art. The local interface 230 may have additional elements, which are omitted for simplicity, such as controllers, buffers (caches), drivers, repeaters, and receivers, to enable communications. Further, the local interface 230 may include address, control, and/or data connections to enable appropriate communications among the aforementioned components.

The processor 202 is a hardware device for executing the software 220, particularly that stored in the memory 210. The processor 202 can be any custom made or commercially available processor, a central processing unit (CPU), an auxiliary processor among several processors associated with the computer 200, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc, or a 68xxx series microprocessor from Motorola Corporation.

The memory 210 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 210 may incorporate electronic, magnetic, optical, and/or other types of storage media. Note that the memory 210 can have a distributed architecture, where various components are situated remote from one another, but can be accessed by the processor 202.

As is shown by FIG. 2, the memory 210 contains a buffer 212 therein, otherwise known as a designated series of memory cells. The buffer 212 is capable of temporarily storing received data, as is explained in detail below with regard to FIG. 4. Specifically, the buffer 212 temporarily stores carrier frequencies and station identification call letters.

The software 220 located within the memory 210 may include one or more separate programs, each of which comprises an ordered listing of executable instructions for implementing logical functions. In the example of FIG. 2, the software 220 located within the memory 210 defines the functionality performed by the DAB receiver 100 in determining a manner in which to format and present received analog audio streams and digital audio streams.

When a portion of the DAB receiver 100 is partially implemented in software, as is shown in FIG. 2, it should be noted that the software 220 can be stored on any computer-readable medium, for use by, or in connection with, any computer related system or method. In the context of this document, a computer readable medium is an electronic, magnetic, optical, or other physical device or means that can contain or store a computer program, for use by, or in connection with, a computer related system or method. The software 220 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by, or in connection with, the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the DAB receiver 100 is implemented entirely in hardware, the DAB receiver 100 can be implemented with any or a combination of the following technologies, which are each well known in the art: a discrete logic circuit(s) having logic gates for implementing logic functions upon data signals; an application specific integrated circuit ASIC) having appropriate combinational logic gates; a programmable gate array(s) (PGA); and a field programmable gate array (FPGA), among others.

It should be noted that other configurations of the memory 210 and processor 202 might be provided. As an example, the memory 210 may alternatively be embedded on the processor 202. Of course, other configurations fall within the scope of the present invention.

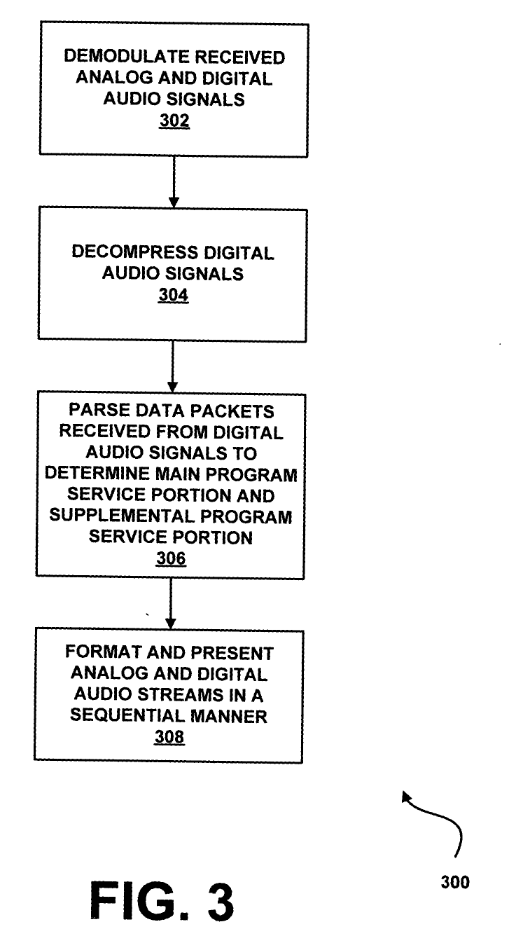

FIG. 3 is a flowchart 300 illustrating a method of providing a user of the DAB receiver 100 (FIG. 1) with access to a received analog audio signal broadcast and a received digital audio signal broadcast, in accordance with the first exemplary embodiment of the invention. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

As is shown by block 302, received analog and digital audio signals are demodulated to remove a carrier signal. The digital audio signals are also decompressed 304. As is shown by block 306, data packets received from the digital audio signals are parsed, resulting in a determination as to what portions of the digital audio stream are part of a main program service and what portions of the digital audio stream are part of a supplemental program service.

As is shown by block 308, analog audio streams and digital audio streams are then formatted and presented to the user in a sequential manner, for selection via use of the control device 170 (FIG. 1). The process of formatting and presenting analog audio streams and digital audio streams, as performed by the computer 200 (FIG. 1), is described in further detail with regard to the description of the flowchart of FIG. 4.

FIG. 4 is a flowchart 400 further illustrating the steps of formatting and presenting received analog audio streams and received digital audio streams, as performed by the computer 200 (FIG. 1) located within the DAB receiver 100 (FIG. 1). As is shown by block 402, carrier frequencies are displayed on the display 160 (FIG. 1), preferably one at a time, although more than one carrier frequency may be displayed at a time. It should be noted that displayed carrier frequencies may be carrier frequencies known to those having ordinary skill in the art. Alternatively, the displayed carrier frequencies may be carrier frequencies of received analog audio broadcasts. In addition, representations of the carrier frequencies may alternatively be displayed, such as, for example, station identification call letters. Of course, in accordance with another alternative embodiment of the invention, both the numerical carrier frequencies and a representation of the carrier frequencies, such as the station identification call letters, may be displayed. The user of the DAB receiver 100 (FIG. 1) uses the control device 170 (FIG. 1) to select one of the carrier frequencies so as to listen to an associated radio station (block 404).

When a carrier frequency is selected, the computer 200 (FIG. 1) allows an associated analog audio stream to be played and heard by the user (block 406). During playing of the selected analog audio stream, the selected carrier frequency and associated station identification call letters are displayed on the display 160 (FIG. 1). After a period of time, the computer 200 (FIG. 1) determines if a digital audio broadcast providing a digital version (i.e., high definition) of the analog audio stream being played has been received and processed by the DAB receiver 100 (FIG. 1) (block 408). Of course, the computer 200 (FIG. 1) may continuously search for the digital version, instead of waiting for a period of time to pass. If a digital version of the analog audio stream has been received and processed by the DAB receiver 100 (FIG. 1), the computer 200 (FIG. 1) selects an associated digital audio stream to replace the analog audio stream and causes the DAB receiver 100 (FIG. 1) to play the digital audio stream (block 410). During playing of the digital audio stream, the display 160 (FIG. 1) may display an icon or word demonstrating that a digital audio stream is being played by the DAB receiver 100 (FIG. 1).

As is shown by block 412, if the digital audio stream is being played, the computer 200 (FIG. 1) also determines if supplemental program services are also made available by the received digital audio stream, as processed by the HD radio module 120 (FIG. 1). If supplemental program services are available, the computer 200 (FIG. 1) makes the supplemental program services sequentially available for selection by the user (block 414) via use of the control device 170 (FIG. 1).

Sequential availability of the supplemental program services is performed by making the currently playing digital audio stream a main program service, while each supplemental program service is assigned different station identification call letters, which are similar to the station identification call letters of the main program service. As an example, if the station identification call letters of the main program service are WBRU, the first supplemental program service may be assigned the station identification call letters WBRU-1 and the second supplemental program service may be assigned the station identification call letters WBRU-2. The station identification call letters of the main program service and the supplemental program services are then sequentially arranged by the computer 200 (FIG. 1) in a manner similar to the typical sequential arrangement of carrier frequencies. Therefore, the user of the DAB receiver 100 (FIG. 1) is capable of scanning through the carrier frequencies, the main program service, and the supplemental program services by using the control device 170 (FIG. 1). It should be noted that, the station identification call letters of the main program service and the supplemental program services may be temporarily stored within the buffer 212 (FIG. 2) of the memory 210 (FIG. 2).

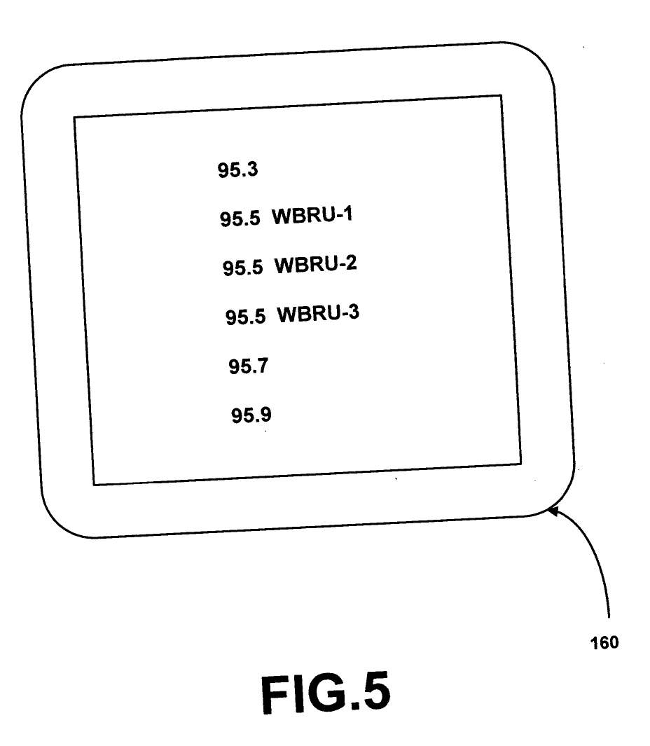

In accordance with an alternative embodiment of the invention, if the main program service, having the call letters WBRU, is received via carrier frequency 95.5, the main program service may be assigned the station identification call letters WBRU-1. In addition, the first supplemental program service may be assigned the station identification call letters WBRU-2 and the second supplemental program service may be assigned the station identification call letters WBRU-3. The station identification call letters of the main program service and the supplemental program services are then sequentially arranged by the computer 200 (FIG. 1) in a manner similar to the typical sequential arrangement of carrier frequencies. An example of a screen display resulting from the assignment of call letters and sequential arrangement is provided by FIG. 5.

As an example of the above described process, in accordance with the first exemplary embodiment of the invention, if the display 160 (FIG. 1) was illustrating station identification call letters associated with a main program service, turning the control device 170 (FIG. 1) to the right would result in the computer 200 (FIG. 1) (i.e., the processor, as instructed by the memory) causing the display 160 (FIG. 1) to illustrate station identification call letters associated with the first supplemental program service, and thereafter the station identification call letters associated with the second supplemental program service. Alternatively, if the control device 170 (FIG. 1) is turned to the left, the display 160 (FIG. 1) may illustrate the next lowest carrier frequency. In addition, when listening to the second supplemental program service, turning the control device 170 (FIG. 1) to the right would result in display of the next higher carrier frequency, and playing of an associated program.

In addition to the abovementioned, in accordance with the first exemplary embodiment of the invention, when supplemental program services and main program services have been made available, the user of the DAB receiver 100 (FIG. 1) may scan through the main program services and the supplemental program services via use of the control device 170 (FIG. 1). As an example, if a first main program service is available with a first series of supplemental program services, the user may scan through the first series of supplemental program services and the first main program service. In addition, if a second main program service is available with a second series of supplemental program services, the user may scan through the second series of supplemental program services, the second main program service, and also scan through the first series of supplemental program services and the first main program service. Specifically, in accordance with the first exemplary embodiment of the invention, main program services and the supplemental program services remain available for selection.

It should be noted that while sequential arrangement may entail supplemental program services being listed immediately after the associated main program service, or immediately before the associated main program service, sequential arrangement may also entail listing supplemental program services immediately above or below the associated main program service.

To prevent a user from accidentally leaving the supplemental program services, different methods may be utilized, one of which is described hereafter. Arrows or other visual objects may be used to signify to a user that the supplemental program service presently tuned in is the last supplemental program service, within a group of supplemental program services, that is associated with the main program service. As an example, when the second supplemental program service, of the above example, is tuned in, an arrow facing to the left might appear on the display to illustrate to the user that other supplemental program services may be tuned in by turning the control device 170 (FIG. 1) to the left, and that turning the control device 170 (FIG. 1) to the right would result in display of the next higher carrier frequency, outside of the group of supplemental program services, and playing of an associated program.

It should be noted that in accordance with an alternative embodiment of the invention, the main program service and the supplemental program services may be made available to the user of the DAB receiver 100 (FIG. 1) for a temporary period of time. As an example, the computer 200 (FIG. 1) may make the main program service and the supplemental program services available as long as the user has not scanned past the main program service and supplemental program services. If the user scans past the main program service and supplemental program services, the DAB receiver 100 (FIG. 1) may make the original analog audio stream provided on the associated carrier frequency available again. Using this process prevents the user of the DAB receiver 100 (FIG. 1) from having to scan through the many different supplemental program services, which may be made available at different carrier frequencies, all the time.

Of course, other variants of making the main program service and supplemental program services available via the DAB receiver 100 (FIG. 1) may be provided. As an example, while a tuned in supplemental program service may remain available while tuned in, other supplemental program services associated with the same main program service may be made available for a predefined period of time, after which the other supplemental program services may no longer be available by scanning with the control device 170 (FIG. 1). To access the main program service and other supplemental program services, the user of the DAB receiver 100 (FIG. 1) would have to tune to the original carrier frequency and wait for the digital audio broadcast to once again provide the main program service and the other supplemental program services.

If the DAB receiver 100 (FIG. 1) also contains pre-select buttons, where a user of the DAB receiver 100 (FIG. 1) may assign a specific carrier frequency to a specific pre-select button, the user may also assign a supplemental program service or a main program service to a specific pre-select button. If a pre-select button is assigned to a supplemental program service and the pre-select button is selected, the computer 200 (FIG. 1) selects the supplemental program, as processed and made available by the HD radio module 120 (FIG. 1) and allows an associated digital audio stream to be driven by the amplifier 180 (FIG. 1) and played by the speaker 190 (FIG. 1).

It should be noted that when a main program service or supplemental program services is tuned in by the DAB receiver 100 (FIG. 1), associated data received from the digital audio stream may be displayed on the display 160 (FIG. 1). As an example, displayed data may include the carrier frequency on which an associated digital audio broadcast was received, the station identification call letters, a song title, and an artist name associated with a playing song.

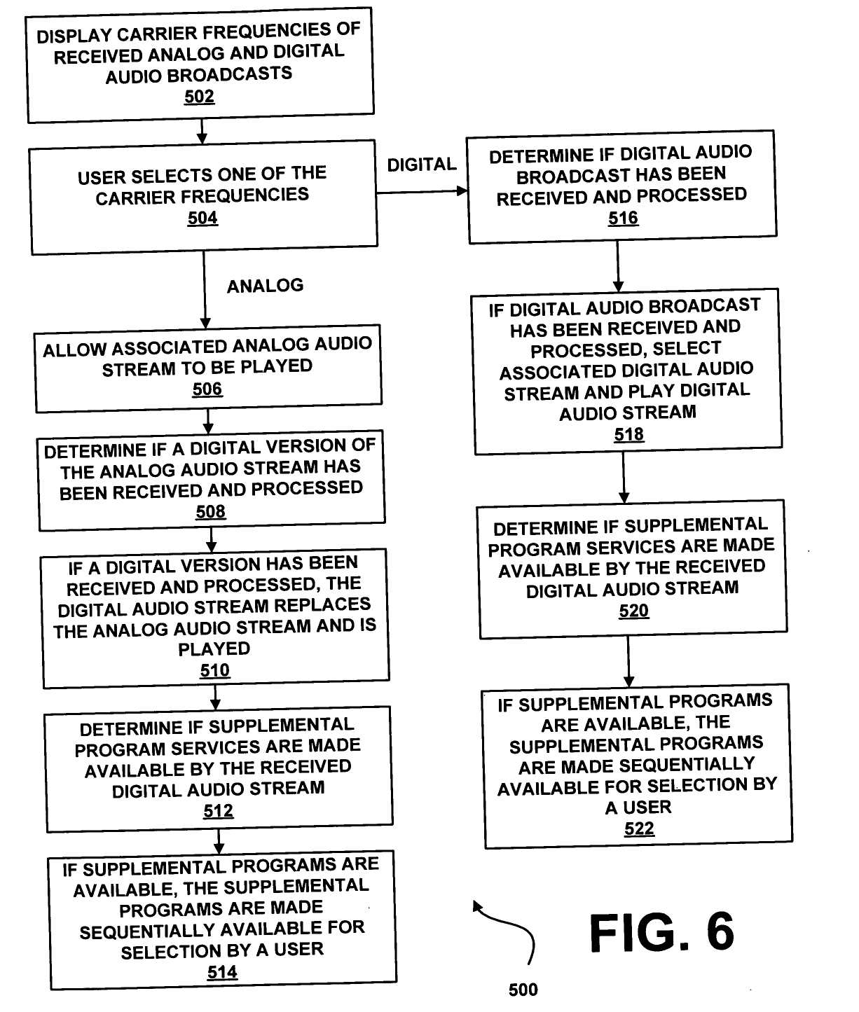

In accordance with a second exemplary embodiment of the invention, a selected carrier frequency may be associated with a digital audio broadcast. FIG. 6 is a flowchart 500 further illustrating the steps of formatting and presenting received analog audio streams and received digital audio streams, as performed by the computer 200 (FIG. 1) located within the DAB receiver 100 (FIG. 1), if the DAB receiver 100 (FIG. 1) also receives digital audio broadcasts at a carrier frequency that is different from the carrier frequency used to transmit analog audio broadcasts. As is shown by block 502, carrier frequencies of received analog and digital audio broadcasts are displayed on the display 160 (FIG. 1), preferably one at a time, although more than one carrier frequency may be displayed at a time. The user of the DAB receiver 100 (FIG. 1) uses the control device 170 (FIG. 1) to select one of the carrier frequencies so as to listen to an associated radio station (block 504).

When a carrier frequency associated with an analog audio broadcast is selected, the computer 200 (FIG. 1) allows an associated analog audio stream to be played and heard by the user (block 506). During playing of the selected analog audio stream, the selected carrier frequency and associated station identification call letters are displayed on the display 160 (FIG. 1). After a period of time, the computer 200 (FIG. 1) determines if a digital audio broadcast providing a digital version (i.e., high definition) of the analog audio stream being played has been received and processed by the DAB receiver 100 (FIG. 1) (block 508). Of course, the computer 200 (FIG. 1) may continuously search for the digital version, instead of waiting for a period of time to pass. If a digital version of the analog audio stream has been received and processed by the DAB receiver 100 (FIG. 1), the computer 200 (FIG. 1) selects an associated digital audio stream to replace the analog audio stream and causes the DAB receiver 100 (FIG. 1) to play the digital audio stream (block 510). During playing of the digital audio stream, the display 160 (FIG. 1) may display an icon or word demonstrating that a digital audio stream is being played by the DAB receiver 100 (FIG. 1).

As is shown by block 512, if the digital audio stream is being played, the computer 200 (FIG. 1) also determines if supplemental program services are also made available by the received digital audio stream, as processed by the HD radio module 120 (FIG. 1). If supplemental program services are available, the computer 200 (FIG. 1) makes the supplemental 495 program services sequentially available for selection by the user (block 514) via use of the control device 170 (FIG. 1).

Alternatively, if a carrier frequency associated with a digital audio broadcast is selected, the computer 200 (FIG. 1) determines if the digital audio broadcast has been received and processed by the DAB receiver 100 (FIG. 1) (block 516). If the digital audio broadcast has been received and processed by the DAB receiver 100 (FIG. 1), the computer 200 (FIG. 1) selects an associated digital audio stream and causes the DAB receiver 100 (FIG. 1) to play the digital audio stream (block 518). During playing of the digital audio stream, the display 160 (FIG. 1) may display an icon or word demonstrating that a digital audio stream is being played by the DAB receiver 100 (FIG. 1).

As is shown by block 520, if the digital audio stream is being played, the computer 200 (FIG. 1) also determines if supplemental program services are also made available by the received digital audio stream, as processed by the HD radio module 120 (FIG. 1). If supplemental program services are available, the computer 200 (FIG. 1) makes the supplemental program services sequentially available for selection by the user (block 522) via use of the control device 170 (FIG. 1).

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A system for providing access to audio programs, comprising:
an antenna;
a display;
a control device;
a memory; and
a processor configured by said memory to perform the steps of:
sequentially arranging said audio programs received by said system in accordance with a representation of a carrier frequency, where said audio programs comprise at least one main program service and at least one supplemental program service, said main program service being located within said sequential arrangement at a location of a first carrier frequency at which said main program service was received, and said at least one supplemental program service received at said first carrier frequency being sequentially listed near said main program service; and
displaying said sequentially arranged programs on said display so that said programs may be searched by use of said control device.

2. The system of claim 1, wherein said representation of said carrier frequency is a numerical representation of said carrier frequency.

3. The system of claim 1, wherein said representation of said carrier frequency is station identification call letters.

4. The system of claim 1, wherein said sequentially listing said at least one supplemental program service near said main program service further comprises sequentially listing said at least one supplemental program service immediately after or immediately before said main program service.

5. The system of claim 1, wherein said control device is a knob.

6. The system of claim 1, wherein said control device is at least one button.

7. The system of claim 1, wherein said main program service and said at least one supplemental program service are received by said system via a digital audio broadcast.

8. The system of claim 1, wherein said main program service and said at least one supplemental program service are received at the said first carrier frequency.

9. The system of claim 1, wherein said programs sequentially arranged by said processor also comprise at least one program received as an analog audio broadcast.

10. The system of claim 1, wherein said programs comprise more than one supplemental program service, and wherein said processor is further configured by said memory to perform the step of assigning each supplemental program service similar station identification call letters that are similar to station identification call letters of said main program service.

11. The system of claim 10, wherein said audio programs further comprise analog audio broadcasts, said processor being further configured by said memory to perform the step of allowing a user of said system to cycle through said main program service, supplemental program services, and said analog audio broadcasts by using said control device.

12. The system of claim 1, wherein said memory is embedded on said processor.

13. The system of claim 1, further comprising an output device for allowing a user of said system to hear one of said programs.

14. The system of claim 1, wherein said processor is further configured by said memory to perform the step of causing said system to allow playing of a program selected by said user, that has been selected from said arranged programs via use of said control device.

15. The system of claim 14, further comprising a speaker.

16. The system of claim 14, further comprising a line out output port for allowing an output device to be connected to said system to allow a user to listen to said played program.

17. A method of providing access to at least one supplemental program service, comprising the steps of:
sequentially displaying representations of carrier frequencies of received audio broadcasts;
receiving a selection of an analog audio stream, wherein said analog audio stream is one of said received audio broadcasts;
determining if a digital audio stream, which provides a digital version of said selected analog audio stream, is available, said digital version of said analog audio stream being referred to herein as a main program service;
determining if said digital audio stream comprises said at least one supplemental program service; and
sequentially displaying said main program service and said at least one supplemental program service, if said digital audio stream comprises said at least one supplemental program service.

18. The method of claim 17, wherein said representations of said carrier frequencies are numerical representations of said carrier frequencies.

19. The method of claim 17, wherein said representations of said carrier frequencies are station identification call letters.

20. The method of claim 17, further comprising the step of allowing said analog audio stream associated with a selected carrier frequency to be heard prior to said step of determining if said digital audio stream is available.

21. The method of claim 20, further comprising the step of displaying a station identification associated with said analog audio stream during said step of allowing said analog audio stream associated with said selected carrier frequency to be heard.

22. The method of claim 17, further comprising the step of replacing said analog audio stream associated with said selected carrier frequency with said digital audio stream prior to said step of determining if said digital audio stream comprises said at least one supplemental program service.

23. The method of claim 17, further comprising the step of displaying a supplemental program service station identification associated with said at least one supplemental program service during said step of sequentially displaying said main program service and said at least one supplemental program service.

24. The method of claim 17, further comprising the steps of:
playing said digital audio stream if available;
displaying a main program service station identification associated with said main program service; and
displaying a separate supplemental program service station identification for each of said at least one supplemental program service, wherein each of said separate supplemental program service station identification derived from said digital audio stream is similar to each other, and wherein each of said separate supplemental program service station identifications derived from said digital audio stream is similar to said main program service station identification.

25. The method of claim 17, further comprising the step of providing a visual guideline to prevent accidental tuning past said main program service and said at least one supplemental program service.

26. A method of providing access to supplemental program services, comprising the steps of:
sequentially displaying representations of carrier frequencies of received audio broadcasts;
determining if said digital audio stream comprises at least one supplemental program service; and
sequentially displaying said at least one supplemental program service, if said digital audio stream comprises said at least one supplemental program service.

27. The method of claim 26, wherein said representation of said carrier frequencies are numerical representations of said carrier frequencies.

28. The method of claim 26, wherein said representation of said carrier frequencies are station identification call letters.

29. The method of claim 26, further comprising the step of allowing a digital audio stream associated with a selected carrier frequency to be heard.

30. The method of claim 26, further comprising the step of displaying a supplemental program service station identification associated with said at least one supplemental program service during said step of sequentially displaying said at least one supplemental program service.

31. The method of claim 26, further comprising the steps of:
playing said digital audio stream if available;
displaying a main program service station identification associated with said main program service; and
displaying a separate supplemental program service station identification for each of said at least one supplemental program service, wherein each of said separate supplemental program service station identification derived from said digital audio stream is similar to each other, and wherein each of said separate supplemental program service station identifications derived from said digital audio stream is similar to said main program service station identification.

32. A system for providing access to supplemental program services, comprising:
means for sequentially displaying representations of carrier frequencies of received audio broadcasts;
means for receiving a selection of an analog audio stream, wherein said analog audio stream is one of said received audio broadcasts;
means for determining if a digital audio stream, which provides a digital version of said selected analog audio stream, is available, said digital version of said analog audio stream being referred to herein as a main program service;
means for determining if said digital audio stream comprises said at least one supplemental program service; and
means for sequentially displaying said main program service and said at least one supplemental program service, if said digital audio stream comprises said at least one supplemental program service.
